(19) United States
(12) Patent Application Publication
(10) Pub. No.: US 2026/0169748 A1
(43) Pub. Date: Jun. 18, 2026

(54) MISALIGNED MEMORY ACCESSES TO AN ADDRESS-SLICED CACHE

(71) Applicant: Intel Corporation, Santa Clara, CA (US)

(72) Inventors: Richard Klass, Hillsboro, OR (US); Mark Dechene, Hillsboro, OR (US); Ryan Carlson, Hillsboro, OR (US); Paula Petrica, Portland, OR (US)

(73) Assignee: Intel Corporation, Santa Clara, CA (US)

(21) Appl. No.: 18/986,418

(22) Filed: Dec. 18, 2024

(51) Int. Cl. G06F 9/38; G06F 9/30

(52) U.S. Cl. CPC G06F 9/3816; G06F 9/30043; G06F 9/3836

(57) ABSTRACT

Techniques for misaligned memory to accesses an address-sliced cache are described. In an embodiment, an apparatus includes a data cache; and a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value.

### BACKGROUND

An information processing system may include one or more memories in which to store data, instructions, and/or other information. A processor core in an information processing system may include circuitry to perform operations to store data, instructions, and/or other information in the one or more memories.

### BRIEF DESCRIPTION OF THE DRAWINGS

Various embodiments in accordance with the present disclosure will be described with reference to the drawings, in which:

FIG. 1 is a block diagram of a processor core in which embodiments may be implemented.

FIG. 2A a block diagram of a memory execution sub-unit according to embodiments.

FIG. 2B is a block diagram of a split register according to embodiments.

FIG. 3 illustrates examples of misaligned memory accesses according to embodiments.

FIG. 4 illustrates a method for misaligned memory accesses in an address-sliced cache according to embodiments.

FIG. 5 illustrates an example computing system.

FIG. 6 illustrates a block diagram of an example processor that may have one or more cores and an integrated memory controller.

FIG. 7A is a block diagram illustrating both an example in-order pipeline and an example register renaming, out-of-order issue/execution pipeline according to examples.

FIG. 7B is a block diagram illustrating both an example of an in-order architecture core and an example register renaming, out-of-order issue/execution architecture core to be included in a processor according to examples.

FIG. 8 illustrates examples of execution unit(s) circuitry.

FIG. 9 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for misaligned memory accesses to an address-sliced cache. In embodiments, an apparatus includes a data cache; and a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value.

As mentioned in the background section, a processor, processor core, or execution core (any of which may be referred to as a core) in an information processing system or other electronic product may include circuitry and/or other hardware or structures to perform operations to store data, instructions, and/or other information in one or more memories. Instruction set architectures (ISAs) of some cores allow memory accesses to regions of memory that are not aligned to a cacheline or access size boundary. These accesses can also cross a cacheline boundary, resulting in access to two physical lines in the cache to produce data for one instruction execution. These types of memory accesses may be referred to as misaligned memory accesses and/or cacheline split operations.

A problem may arise on how to handle cacheline split operations when consecutive cache lines do not reside in a single cache, such as an address-sliced data cache. The use of embodiments may provide for performing one or more of these operations faster and/or more efficiently and/or otherwise provide for faster execution of software, higher overall performance, and/or lower power consumption.

While various features are described in the context of the below example core organization, alternative embodiments may implement such features in other core organizations.

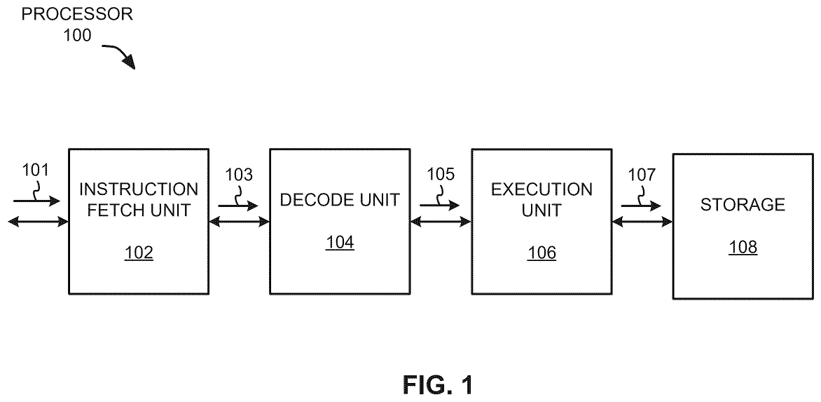

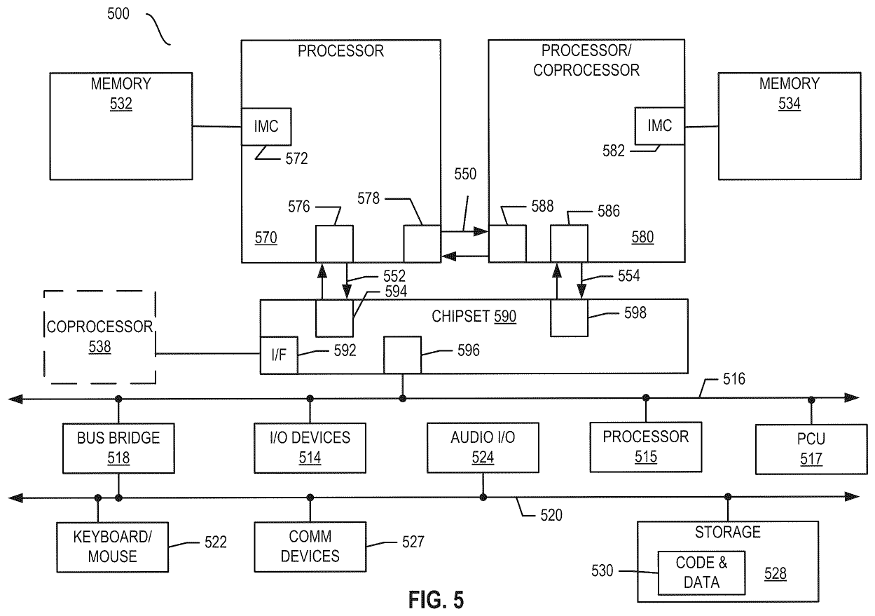

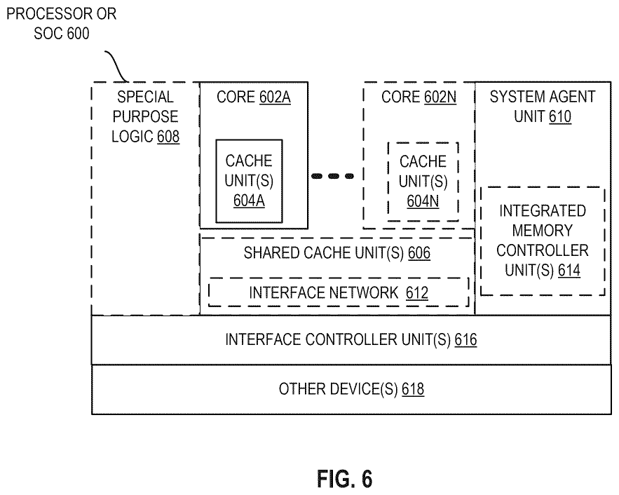

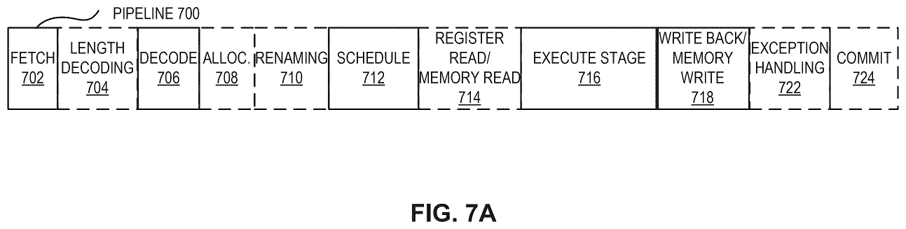

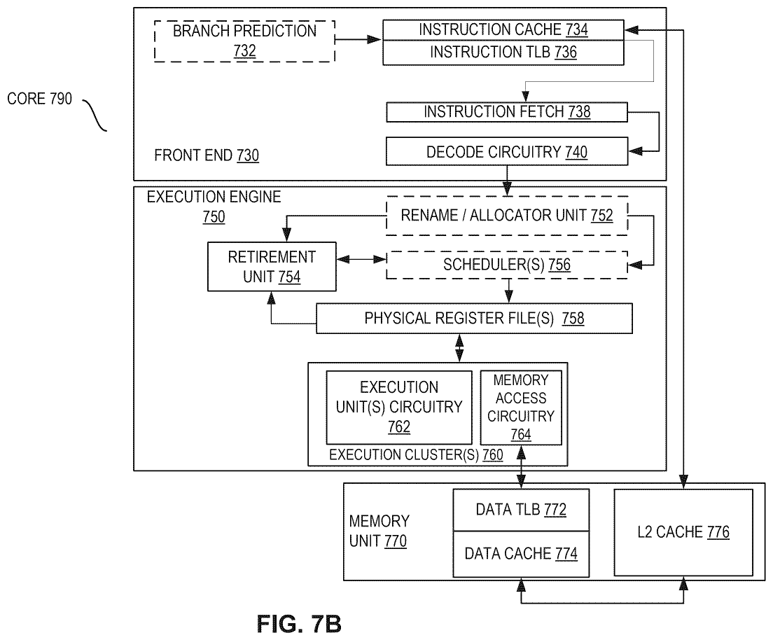

FIG. 1 is a block diagram of an embodiment of a processor core 100 in which some embodiments may be implemented. In some embodiments, the processor core may be implemented for or in a general-purpose processor (e.g., a central processing unit (CPU) or other general-purpose microprocessor of the type used in servers, desktop, laptop, smart phones, or other computers). Alternatively, the processor core may be implemented for or in a special-purpose processor. Examples of suitable special-purpose processors include, but are not limited to, network processors, communications processors, graphics processors, co-processors, digital signal processors (DSPs), embedded processors, and controllers (e.g., microcontrollers). The processor and/or processor core may be disposed on a semiconductor die or integrated circuit and may include hardware (e.g., transistors, circuitry, etc.). As examples, processor core 100 in FIG. 1 may correspond to any core within processor 570 or 580 in FIG. 5, any of cores 602A to 602N in FIG. 6, and/or core 790 in FIG. 7B.

The processor core 100 has an instruction fetch unit 102, a decode unit 104, an execution unit 106, and storage 108. The instruction fetch unit or fetch unit may fetch instructions 101. The instructions 101 may represent macroinstructions, instructions of an instruction set of the processor, instructions that the decode unit 104 is able to decode, or the like. The fetch unit 102 may be coupled to receive the instructions 101 from on-die storage (not shown) of the processor, such as, for example, one or more caches, buffers, queues, or the like, and/or from system memory. The decode unit 104 is coupled with the fetch unit 102 to receive the fetched instructions 103 (e.g., the same instructions but reordered), and may be operable to decode the fetched instructions 103 into one or more relatively lower-level instructions or control signals 105 (e.g., one or more microinstructions, micro-operations (uops), micro-code entry points, decoded instructions, or control signals, etc.).

Together, fetch unit 102 and decode unit 104, possible along with a branch prediction unit, a microcode sequencing unit, and/or other circuitry or units, may be referred to as a front-end.

Execution unit 106 may represent one or more execution units coupled with the decode unit to receive the one or more lower-level instructions or control signals 105 and may be operable to generate corresponding results 107. The results 107 may be stored in on-die storage 108 of the processor (e.g., registers, caches, etc.) or in off-die storage (e.g., system memory).

In embodiments, a multi-level cache hierarchy includes level 0 (L0) caches, a physically and/or logically partitioned level 1 (L 1 ) cache, and a physically and/or logically partitioned level 2 (L2) cache, and core 100 shares a level 3 (L3 ) cache or last-level cache (LLC) with other cores of a multicore processor. An L0 data cache to store data and an L0 instruction cache to store instructions may be included in execution unit 106 to improve data/instruction access speed. In embodiments, the various components of the core, including the execution unit 106, are coupled to the L1 cache via a crossbar which supports multiple non-interfering connections with the L1 cache.

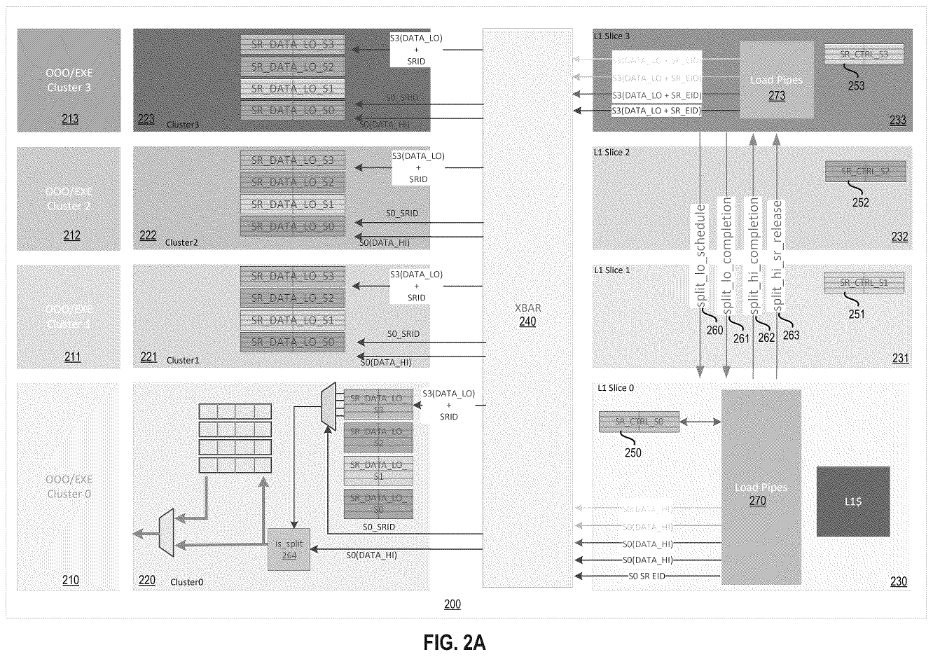

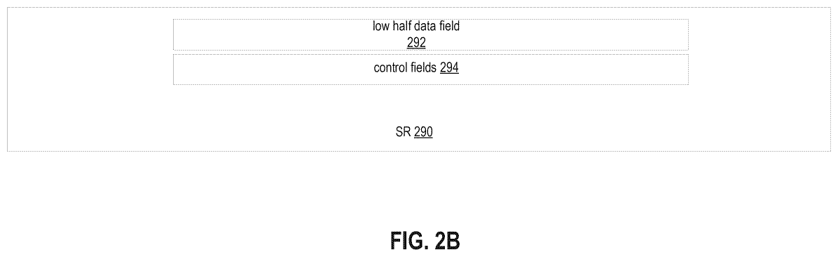

To avoid obscuring the description, a relatively simple processor core 100 has been shown and described. In embodiments, a processor core may include multiple decode units, multiple execution units, and so on, and/or the processor core may optionally include other processor components, such as those shown and described below for any of FIGS. 2A, 4, 7B, and 8.

In embodiments, core 100 may have several execution units 106, which may also be referred to as an execution block or box (note that a “unit,” “block,” or “box,” in this context, typically refers to circuitry, however, in some embodiments, may refer to a combination of hardware circuitry and software). In some embodiments, at least one of the execution units is a memory execution unit (MEM unit, MEM box, or MEM). In embodiments, a MEM unit may process memory requests and page translation requests from the front-end; may process and/or perform load and store operations, returning results and final status (complete/fault) to an out-of-order (OOO) cluster for subsequent instructions and instruction retire; and/or may receive non-core snoops and ensure that correct coherence actions are taken in the core.

In some embodiments, a MEM unit may be subdivided into five distinct sub-units, parts, or parcels: L0 MEM, L1 MEM, L2 MEM, page miss handler (PMH), and prefetchers. In embodiments, L0 MEM is the smallest, fastest unit of memory; L1 MEM is an L1 memory unit with large caches and buffers to support loads and stores with moderate latency; L2 MEM is an L2 memory unit to provide access to an L2 cache and to serve as an interface to the rest of the system (which may be a system-on-chip or SoC); the PMH services page translation misses on behalf of L1 translation lookaside buffers (TLBs), translating linear addresses into physical addresses and producing TLB entries to fill L1 TLBs; and the prefetchers include hardware prefetchers to fill cache lines in caches (e.g., L1 data cache, L2 cache) ahead of predicted demand.

The MEM may also be divided internally into clusters in some places (e.g., L0 MEM) and into slices in other places (e.g., L1 MEM and L2 MEM). Clusters divide the instruction stream into medium-sized groups of contiguous instructions called strands, and then one or more strands may be executing on a cluster at a time. Clusters may be most effective when executing work that is adjacent in program order to other work. Slices divide the memory instruction stream based upon the addresses the instructions access. Slices may create an inherent proof that certain memory instructions may mostly ignore other instructions, and therefore reduce ordering and correctness checks, when different memory instructions have been assigned to different slices. Slices may be most effective when the memory address pattern is relatively balanced across cachelines.

To transition between the cluster domain and the slice domain, memory operations traverse a crossbar. Travelling from the slice domain to the cluster domain also traverses through the crossbar.

Embodiments may be implemented in a MEM unit, load/store unit, or elsewhere in a core, processor, and/or system. An example embodiment in a MEM unit is described in connection with FIG. 2A.

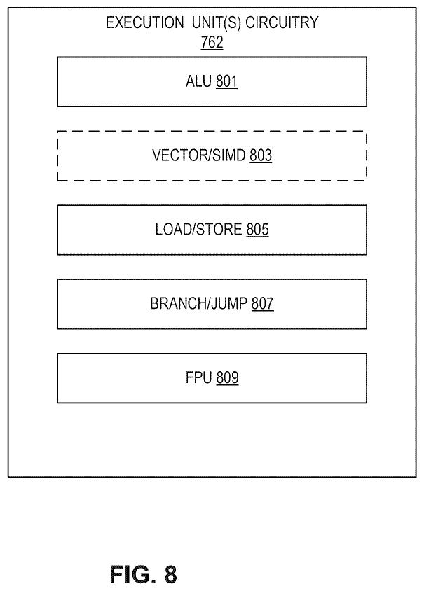

FIG. 2A illustrates a MEM sub-unit 200 of a MEM unit according to an embodiment. As an example, MEM sub-unit 200 may be implemented in circuitry in load/store circuits 805 in FIG. 8 as described below. For the example of FIG. 2A, the illustration and description are based on an L1 sub-unit of a MEM unit that may also include one or more other L1 sub-units, L0 sub-units, L2 sub-units, PMH sub-units, and prefetcher sub-units.

MEM sub-unit 200 has interfaces with one or more out-of-order (OOO) and/or execution (EXE) units (e.g., OOO/EXE clusters 210, 211, 212, 213) and a front-end (FE) unit (not shown). The OOO and EXE interfaces may be used to synchronize processing around loads and stores.

In order to provide scalable performance, MEM sub-unit 200 is sliced by address. As shown in FIG. 2A, MEM sub-unit 200 includes four slices (230, 231, 232, 233) of L1 MEM, where each slice contains a different range of address values compared to the other slices, but other numbers of slices are possible. After a load or store has passed address generation, the appropriate slice for that memory operation may be determined by looking at the linear address bits of the load or store. In the case of line splits, multiple slices may be needed to produce the final load/store result.

Outside of the sliced memory domain, MEM sub-unit 200 includes per-cluster portions 220, 221, 222, and 223, which transmit load uops, store address uops, store data uops, etc. from OOO/EXE clusters 210, 211, 212, and 213, respectively, as well as transmit results in the opposite direction.

MEM sub-unit crossbar 240 is configured to transmit information (signals, data, etc.) between slice and cluster portion of MEM sub-unit 200. While loads and stores have specific target slices based on their address, the information may be broadcast to all slice and cluster portions, and the portions may make decisions on what information to catch and process.

In embodiments, each slice of MEM sub-unit 200 is associated with a split register (SR) 290 as shown in FIG. 2B, which might not be physically located in the slice, but the control logic may be within the slice (e.g., SR_CTRL_S0 250, SR_CTRL_S0 251, SR_CTRL_S0 252, SR_CTRL_S0 253 shown in FIG. 2A), and the registers may be logically associated with the low-half slice of a split load.

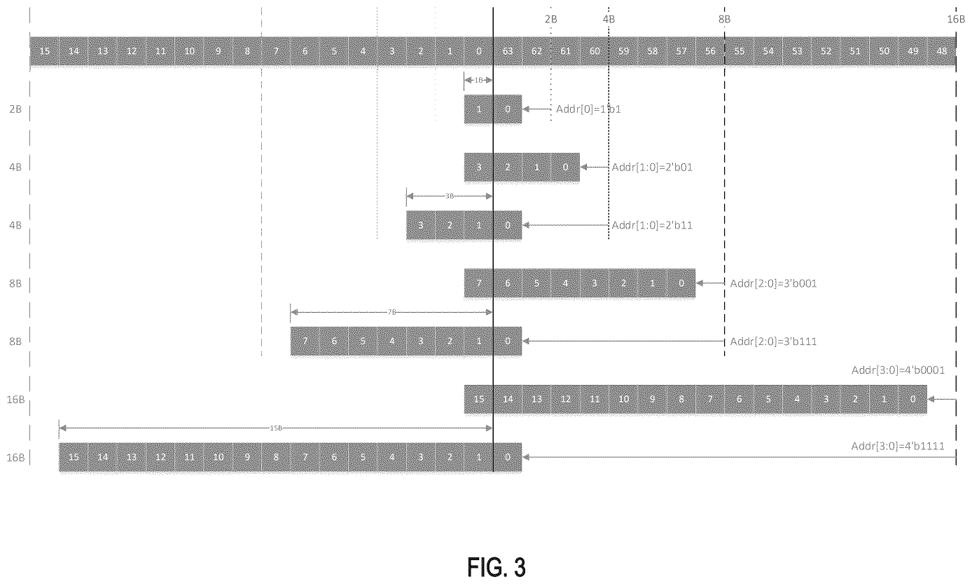

In embodiments, misaligned memory accesses and/or cacheline split operations may be performed by or in connection with the operation of MEM unit or sub-unit (e.g., MEM sub-unit 200) according to, but not limited by, the following description. FIG. 3 illustrates examples of misaligned memory accesses and/or cacheline split operations according to embodiments. In this description, the term low half may be used to refer to a portion of data (and/or a corresponding operation, signal, etc.) including the lowest order bit position of the data, and the term high half may be used to refer to a portion of data (and/or a corresponding operation, signal, etc.) including the highest order bit position of the data. The terms split_lo and split_hi may also be used, for convenience, to refer to, modify, describe, etc. operations, state, etc. associated with the low half and the high half, respectively.

In embodiments, split load data is assembled in a common datapath through which data is returned to the core from the address-sliced memory, and split stores may be handled by ensuring each half of the split operation is ordered (among the slices) post-retirement when store data is committed. Use of these techniques may increase memory bandwidth to the core by organizing logically adjacent cachelines in physically different memory structures, allowing exploitation of parallelism of address-sliced memory sub-systems in the context of ISAs which support cacheline split operations.

In embodiments, the cacheline split flow includes one or more low half operations followed by one or more high half operations. The high half operation(s), trailing behind the low half operation(s), use information provided by the low half operation(s).

In embodiments, the cacheline split flow is controlled by two groups of signals/indicators (which may be designated by including split_lo in the names in a first group, (for split_lo operations), and split_hi in the names in a second group (fore split_lo operations).

For example, FIG. 2A shows signals split_lo_schedule 260, split_lo_completion 261, split_hi_completion 262, and split_hi_sr_release 263.

In embodiments, split loads are completed using a split register, such as SR 290, in the common datapath. There may be SRs per slice, but their control storage field(s) (e.g., 294 in FIG. 2B) and data storage field(s) (e.g., 292 in FIG. 2B) may be distributed between the slice (e.g., control, allocation/deallocation) and cluster datapaths. A data SR in the common datapath may hold the low half data (e.g., shown as 291 in FIG. 2B) for use by the high half operation.

In embodiments, split_lo is scheduled first, allocates an SR if it does not already have one, otherwise it is recycled. If it can complete (bind to data), it populates the correct bytes into the data SR in the common datapath, but does not send completion signal(s)/message(s)/packet (e.g., wakeup signal(s)/message(s)/packet (which may be referred to as wakeup) or writeback signal(s)/message(s)/packet (which may be referred to as writeback)) to the OOO/EXE unit(s).

Upon scheduling in the load pipe (e.g., one or more stages in a load pipeline (e.g., 270 and 273 shown in FIG. 2A) of an instruction processing pipeline), and as it flows through the load pipe, split_lo communicates to its slice neighbor (e.g., next higher slice) the SR identifier (SRID), physical address, attributes, and completion information needed to control split_hi. Once split_hi is allowed to complete (relative to the split_lo), it sends writeback valid or load data information, merges its data with the split_lo data already stored in the data SR, and sends a writeback to the OOO/EXE unit(s).

In embodiments, split_hi includes sending wakeup to the OOO/EXE unit(s) on every pass through the pipeline like a regular load, but split_lo operations will not send wakeup (or writeback) to OOO/EXE unit(s).

Embodiments may include one reservation station (RS) dispatch just like a regular load, but it is handled by two different memory slices instead of only one memory slice. Each slice uses an address generation unit (AGU) packet to determine if the load is a split_hi or split_lo by examining an is_split signal or indicator (e.g., shown as 264 in FIG. 2A) and linear address bits. Both split_hi and split_lo use the same AGU port for each memory slice.

In embodiments, after split_lo is scheduled in its slice's main load pipe, it sends a wakeup to initiate split_hi operation(s) in the adjacent slice. The wakeup message contains the SRID that split_hi stores in the load buffer. In response, the split_hi operation(s) are scheduled and attempt to complete with the SR provided by split_lo.

In embodiments, both split_lo and split_hi complete like normal operations, but only split-hi drives a writeback to the OOO/EXE units.

In embodiments, the SR control logic is implemented in the slices. The split register data may reside in the common datapath in integer clusters, vector clusters, and/or both. The split_lo slice controls the SR allocation/deallocation. The data portion of the SRs, in the clusters, is written by split_lo when split_lo writes back. It does not have valid bits associated with it, and simply gets overwritten when a new split_lo that allocated the same SR writes back again. Since the SRs are not deallocated in slices until split_hi writes back and sends completion information to the split_lo slice, split_hi writeback is guaranteed to use the split_lo SR data before a new split_lo allocates the same SR.

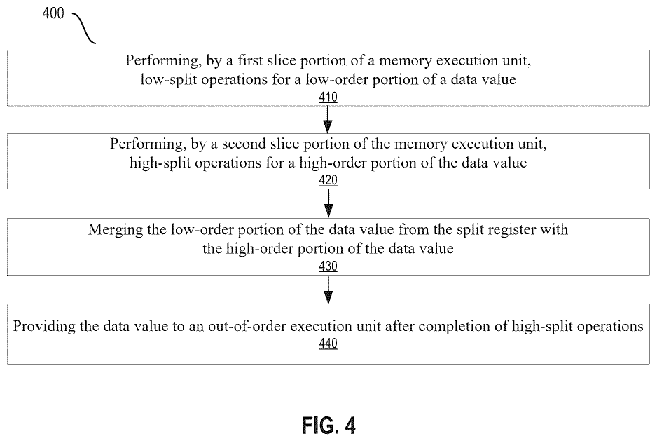

FIG. 4 illustrates a method 400 for misaligned memory accesses operations according to embodiments. Method 400 may be performed by and/or in connection with the operation of a MEM sub-unit such as MEM sub-unit 200 as described above.

Box 410 represents performing, by a first slice portion of a memory execution unit, low-split operations for a low-order portion of a data value. The low-split operations may be controlled by one or more control fields of a split register in the first slice portion of the memory execution unit. The low-split operations may include storing the low-order portion of the data value in the split register for use in one or more of high-split operations.

Box 420 represents performing, by a second slice portion of the memory execution unit, high-split operations for a high-order portion of the data value. The high-split operations are performed after and/or in response to completion (as may be signaled by the first slice portion to the second slice portion) of the low-split operations.

The low-split operations and high-split operations, together, may be to load a data value (e.g., a data value misaligned, with respect to a cacheline or a memory granule boundary, in a system memory and/or cache memory).

Box 430 represents merging (e.g., by a cluster portion of the memory execution unit) the low-order portion of the data value from the split register with the high-order portion of the data value.

Box 440 represents providing (e.g., by a cluster portion of the memory execution unit) the data value to an out-of-order execution unit after completion of high-split operations.

FIGS. 5 to 8, each as described below, also illustrate systems, processors, cores, pipelines, execution units, etc. in which embodiments may be implemented, e.g., they may include any or all of the blocks and/or elements shown in FIG. 2A, which may operate according to the techniques and/or method described in the descriptions of FIG. 4.

Example apparatuses, methods, etc.

In embodiments, an apparatus includes a data cache; and a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value.

Any such embodiments may include any or any combination of the following aspects. The one or more low-split operations and the one or more high-split operations are to load the data value. The apparatus also includes a split register to store the low-order portion of the data value for use by the high-split circuitry. The first one or more low-split operations include storing the low-order portion of the data value in the split register. The one or more high-split operations are to be performed after the one or more low-split operations. The memory execution unit also includes multiple cluster portions, wherein each of the cluster portions is to interface with a corresponding out-of-order execution unit. One of the cluster portions is to merge the low-order portion of the data value from the split register with the high-order portion of the data value. One of the cluster portions is to provide the data value to a corresponding out-of-order execution unit after completion of the one or more high-split operations. One or more control fields of the split register are implemented in the first slice portion.

In embodiments, a method includes performing, by a first slice portion of a memory execution unit, a one or more low-split operations for a low-order portion of a data value; and performing, by a second slice portion of the memory execution unit, one or more high-split operations for a high-order portion of the data value.

Any such embodiments may include any or any combination of the following aspects. The one or more low-split operations and the one or more high-split operations are to load the data value. The one or more low-split operations include storing the low-order portion of the data value in a split register for use in one or more of the high-split operations. The one or more high-split operations are performed after the one or more low-split operations. The method also includes merging the low-order portion of the data value from the split register with the high-order portion of the data value. The method also includes providing the data value to an out-of-order execution unit after completion of the one or more high-split operations. One or more of the low-split operations are controlled by one or more control fields of the split register in the first slice portion of the memory execution unit.

In embodiments, a system includes a memory controller to couple a processor core to one or more memories of a system memory. The processor core includes a data cache; and a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value.

Any such embodiments may include any or any combination of the following aspects. One or more low-split operations and the one or more high-split operations are to load the data value. The one or more low-split operations include storing the low-order portion of the data value in a split register to be merged with the high-order portion of the data value by the high-split circuitry. The one or more high-split operations are to be performed after the one or more low-split operations.

In embodiments, an apparatus may include means for performing any function disclosed herein. In embodiments, an apparatus may include a data storage device that stores code that when executed by a hardware processor or controller causes the hardware processor or controller to perform any method or portion of a method disclosed herein. In embodiments, an apparatus may be as described in the detailed description. In embodiments, a method may be as described in the detailed description. In embodiments, a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 5 illustrates an example of a computing system. Multiprocessor system 500 is an interfaced system and includes a plurality of processors or cores including a first processor 570 and a second processor 580 coupled via an interface 550 such as a point-to-point interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes as part of its interfaces 576 and 578; similarly, second processor 580 includes interfaces 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via P-P interconnect, such that either or both processors'local cache information may be stored in the shared cache if a processor is placed into a low power mode.

Network interface 590 may be coupled to a first interface 516 via an interface 596. In some examples, first interface 516 may be a Peripheral Component Interconnect (PCI) interconnect, or an interconnect such as a PCI Express interconnect or another I/O interconnect. In some examples, one of the interfaces couples to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and a storage circuitry 528. Storage circuitry 528 may be one or more non-transitory machine-readable storage media as described below, such as a disk drive or other mass storage device which may include instructions/code and data 530 and may implement the storage ‘ISAB03 in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 6 illustrates a block diagram of examples of a processor 600 and/or SoC that may have one or more cores and an integrated memory controller. The solid lined boxes illustrate a processor 600 with a single core 602A, a system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor, or special-purpose processor, such as, for example, a network or communication processor, compression engine, graphics processor, GPGPU (general purpose graphics processing unit circuitry), a high throughput many integrated cores (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3 ), level 4 (L4), or other levels of cache, such as a last level cache (LLC), and/or combinations thereof. While in some examples an interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures-in-order and Out-of-Order Core Block Diagram

FIG. 7A is a block diagram illustrating both an example in-order pipeline and an example register renaming, out-of-order issue/execution pipeline according to examples. FIG. 7B is a block diagram illustrating both an example of an in-order architecture core and an example register renaming, out-of-order issue/execution architecture core to be included in a processor according to examples. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7B may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7B shows a processor core 790 including front-end unit circuitry 730 coupled to an execution engine unit circuitry 750, and both are coupled to a memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to an instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to a retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to a data cache circuitry 774 coupled to a level 2 (L2) cache circuitry 776. In one example, the memory access circuitry 764 may include a load unit circuitry, a store address unit circuit, and a store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770.

In one example, the instruction cache 734 and the data cache 774 are combined into a single instruction and data cache (not shown) in L2 cache circuitry 776, a level 3 (L3 ) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

FIG. 8 illustrates examples of execution unit(s) circuitry, such as execution unit(s) circuitry 762 of FIG. 7B. As illustrated, execution unit(s) circuity 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

### Emulation (Including Binary Translation, Code Morphing, Etc.)

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

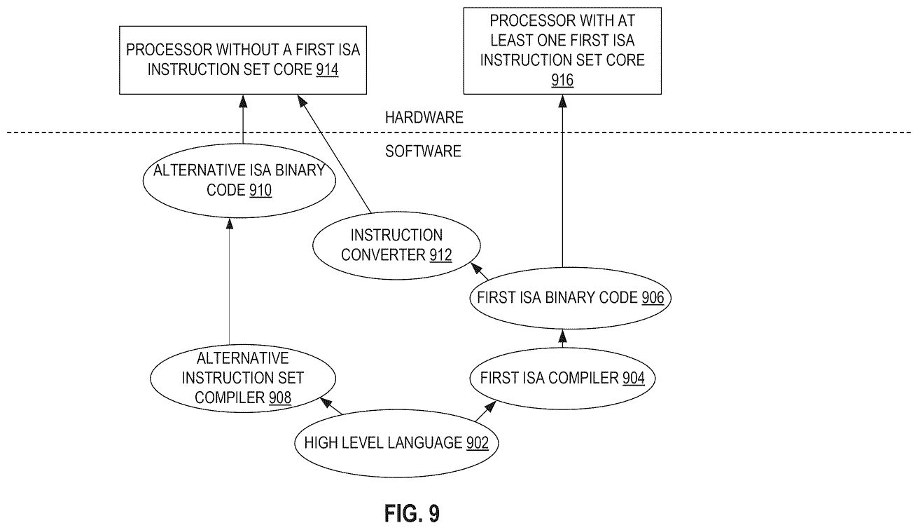

FIG. 9 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 9 shows a program in a high-level language 902 may be compiled using a first ISA compiler 904 to generate first ISA binary code 906 that may be natively executed by a processor with at least one first instruction set architecture core 916. The processor with at least one first ISA instruction set architecture core 916 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 904 represents a compiler that is operable to generate first ISA binary code 906 (e.g., object code) that can, with or without additional linkage processing, be executed on the processor with at least one first ISA instruction set architecture core 916. Similarly, FIG. 9 shows the program in the high-level language 902 may be compiled using an alternative instruction set architecture compiler 908 to generate alternative instruction set architecture binary code 910 that may be natively executed by a processor without a first ISA instruction set architecture core 914. The instruction converter 912 is used to convert the first ISA binary code 906 into code that may be natively executed by the processor without a first ISA instruction set architecture core 914. This converted code is not necessarily to be the same as the alternative instruction set architecture binary code 910; however, the converted code will accomplish the general operation and be made up of instructions from the alternative instruction set architecture. Thus, the instruction converter 912 represents software, firmware, hardware, or a combination thereof that, through emulation, simulation, or any other process, allows a processor or other electronic device that does not have a first ISA instruction set architecture processor or core to execute the first ISA binary code 906.

In the preceding description, numerous specific details, such as component and system configurations, may be set forth in order to provide a more thorough understanding. It will be appreciated, however, by one skilled in the art, that embodiments may be practiced without such specific details. Additionally, some well-known structures, circuits, and other features have not been shown in detail, to avoid unnecessarily obscuring the description.

As used in the description and the drawings, items referred to as blocks, boxes, units, engines, etc. may represent and/or be implemented in hardware, logic gates, memory cells, circuits, circuitry, etc.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases are not necessarily referring to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

In the various examples and embodiments described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

As used in this description and the claims and unless otherwise specified, the use of the ordinal adjectives “first,” “second,” “third,” etc. to describe an element merely indicates that a particular instance of an element or different instances of like elements are being referred to, and is not intended to imply that the elements so described must be in a particular sequence, either temporally, spatially, in ranking, or in any other manner. Also, as used in descriptions of embodiments, a “/” character between terms may mean that an embodiment may include or be implemented using, with, and/or according to the first term and/or the second term (and/or any other additional terms).

In this specification, operations in flow diagrams may have been described with reference to example embodiments of other figures. However, it should be understood that the operations of the flow diagrams may be performed by embodiments other than those discussed with reference to other figures, and the embodiments discussed with reference to other figures may perform operations different than those discussed with reference to flow diagrams. Furthermore, while the flow diagrams in the figures show a particular order of operations performed by certain embodiments, it should be understood that such order is provided as an example (e.g., alternative embodiments may perform the operations in a different order, combine certain operations, overlap certain operations, etc.).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a data cache; and
a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value.

2. The apparatus of claim 1, wherein the one or more low-split operations and the one or more high-split operations are to load the data value.

3. The apparatus of claim 2, further comprising a split register to store the low-order portion of the data value for use by the high-split circuitry.

4. The apparatus of claim 3, wherein the one or more low-split operations include storing the low-order portion of the data value in the split register.

5. The apparatus of claim 4, wherein the one or more high-split operations are to be performed after the one or more low-split operations.

6. The apparatus of claim 5, wherein the memory execution unit also includes multiple cluster portions, wherein each of the cluster portions is to interface with a corresponding out-of-order execution unit.

7. The apparatus of claim 6, wherein one of the cluster portions is to merge the low-order portion of the data value from the split register with the high-order portion of the data value.

8. The apparatus of claim 7, wherein the one of the cluster portions is to provide the data value to a corresponding out-of-order execution unit after completion of the one or more high-split operations.

9. The apparatus of claim 8, wherein one or more control fields of the split register are implemented in the first slice portion.

10. A method comprising:
performing, by a first slice portion of a memory execution unit, a one or more low-split operations for a low-order portion of a data value; and
performing, by a second slice portion of the memory execution unit, one or more high-split operations for a high-order portion of the data value.

11. The method of claim 10, wherein the one or more low-split operations and the one or more high-split operations are to load the data value.

12. The method of claim 11, wherein the one or more low-split operations include storing the low-order portion of the data value in a split register for use in one or more of the high-split operations.

13. The method of claim 12, wherein the one or more high-split operations are performed after the one or more low-split operations.

14. The method of claim 13, further comprising merging the low-order portion of the data value from the split register with the high-order portion of the data value.

15. The method of claim 14, further comprising providing the data value to an out-of-order execution unit after completion of the one or more high-split operations.

16. The method of claim 15, wherein the one or more of the low-split operations are controlled by one or more control fields of the split register in the first slice portion of the memory execution unit.

17. A system comprising:
a processor core including:
a data cache; and
a memory execution unit to access the data cache, the memory execution unit including multiple slice portions, wherein each slice portion is to perform memory access operations for a corresponding address range, and wherein a first slice portion includes low-split circuitry to perform a one or more low-split operations for a low-order portion of a data value and a second slice portion includes high-split circuitry to perform one or more high-split operations for a high-order portion of the data value; and
a memory controller to couple the processor core to one or more memories of a system memory.

18. The system of claim 17, wherein the one or more low-split operations and the one or more high-split operations are to load the data value.

19. The system of claim 18, wherein the one or more low-split operations include storing the low-order portion of the data value in a split register to be merged with the high-order portion of the data value by the high-split circuitry.

20. The system of claim 19, wherein the one or more high-split operations are to be performed after the one or more low-split operations.
